(19) United States
(12) Patent Application Publication
(10) Pub. No.: US 2005/0120853 A1
(43) Pub. Date: Jun. 9, 2005

(54) Power cutting tool

(76) Inventor: Pi-Chu Lin, Chiayi City (TW)

Correspondence Address: WEBB ZIESENHEIM LOGSDON ORKIN & HANSON P.C., 700 Koppers Building, 436 Seventh Avenue, Pittsburgh, PA, 15219-1818, US

(21) Appl. No.: 10/809,110

(22) Filed: Mar. 25, 2004

(30) Foreign Application Priority Data
Dec. 8, 2003 (TW) 092221550

(51) Int. Cl. B26D 1/30

(52) U.S. Cl. 83/602; 30/189

(57) ABSTRACT

A power cutting tool includes an electric driving unit and a cutting unit. The cutting unit includes a first cutting member and a second cutting member that is pivotable relative to said first cutting member and that is driven by a rotary driving member of the electric driving unit such that rotation of the rotary driving member results in pivoting movement of the second cutting member relative to the first cutting member for cutting an object disposed between the first and second cutting members.

### CROSS-REFERENCE TO RELATED APPLICATION

This application claims priority of Taiwanese application no. 092221550, filed on Dec. 8, 2003.

### BACKGROUND OF THE INVENTION

1. Field of the Invention

The invention relates to a cutting tool, more particularly to a power cutting tool that can facilitate cutting of relatively hard objects.

2. Description of the Related Art

Referring to FIG. 1, a conventional cutting tool 1 is shown to include a pair of handle members 11 connected pivotally to each other, and a pair of blade members 12 connected pivotally to front ends of the blade members 11. The blade members 12 are further connected pivotally to each other.

In use, when the handle members 11 are pressed toward each other, the blade members 12 will be driven to move toward each other to permit cutting of an object 10 that is disposed between the blade members 12.

The aforesaid conventional cutting tool 1 is disadvantageous in that the user must exert a large force when cutting a relatively hard object 10, such as a stem of an artificial plant.

### SUMMARY OF THE INVENTION

Therefore, the object of the present invention is to provide a power cutting tool that can facilitate cutting of relatively hard objects.

According to the present invention, a power cutting tool comprises an electric driving unit and a cutting unit. The electric driving unit includes a rotary driving member. The cutting unit includes a first cutting member and a second cutting member pivotable relative to the first cutting member. The second cutting member is driven by the rotary driving member such that rotation of the rotary driving member results in pivoting movement of the second cutting member relative to the first cutting member for cutting an object disposed between the first and second cutting members.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view to illustrate a conventional cutting tool;

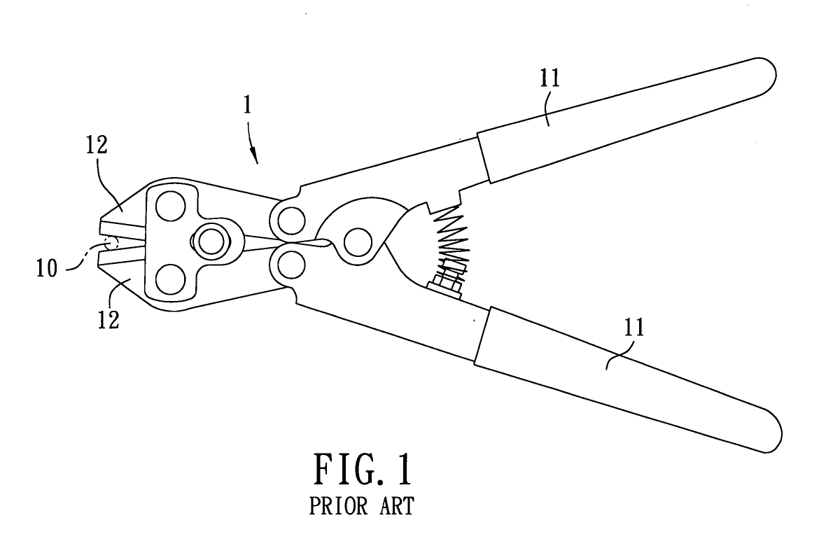

FIG. 2 is a schematic partly sectional view of the first preferred embodiment of a power cutting tool according to the present invention;

FIG. 3 is a fragmentary schematic partly sectional view to illustrate a cutting state of the first preferred embodiment;

FIG. 4 is a schematic view to illustrate operation of a rotary drive member of the first preferred embodiment;

FIG. 5 is a fragmentary schematic partly sectional view to illustrate the second preferred embodiment of a power cutting tool according to the present invention; and

FIG. 6 is a view similar to FIG. 5, but illustrating a cutting state of the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

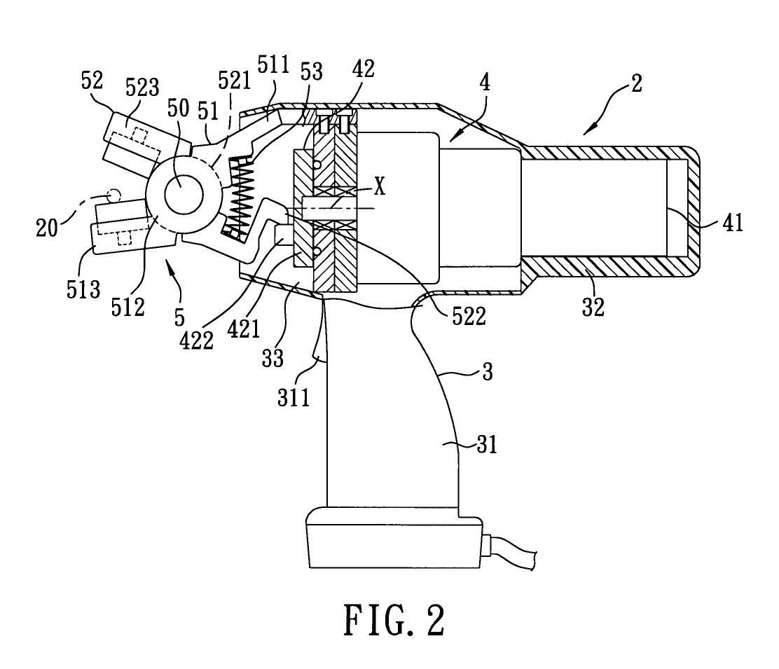

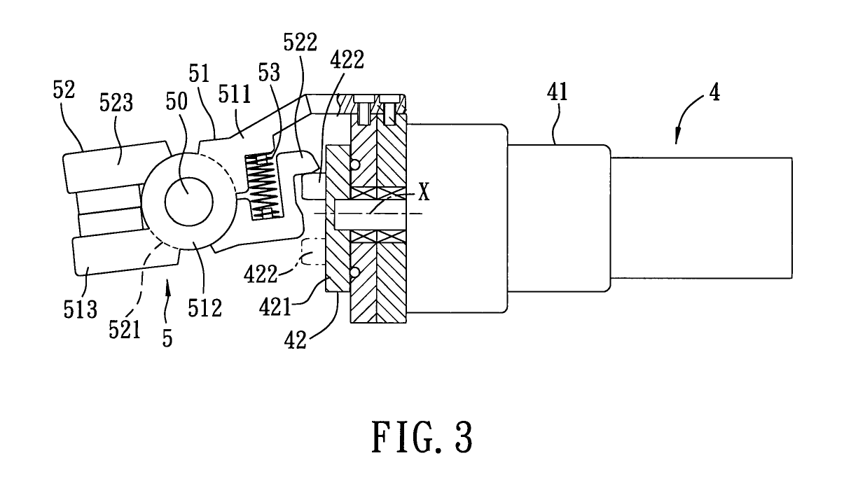

Referring to FIGS. 2 and 3, the first preferred embodiment of a power cutting tool 2 according to the present invention is shown to comprise a casing 3, an electric driving unit 4, and a cutting unit 5.

The casing 3 includes a handle portion 31 and a mounting portion 32 generally transverse to the handle portion 31. The handle portion 31 is adapted for gripping by the user of the power cutting tool 2, and has a power switch 311 mounted thereon. The mounting portion 32 confines a mounting space 33 therein.

The electric driving unit 4 is mounted in the mounting space 33, and includes a power mechanism 41 and a rotary driving member 42 disposed in front of and driven rotatably by the power mechanism 41. In this embodiment, the power mechanism 41 includes an electric motor and a speed reduction device. Since the specific construction of the power mechanism 41 is known in the art and is not pertinent to the claimed invention, a detailed description of the same is omitted herein for the sake of brevity.

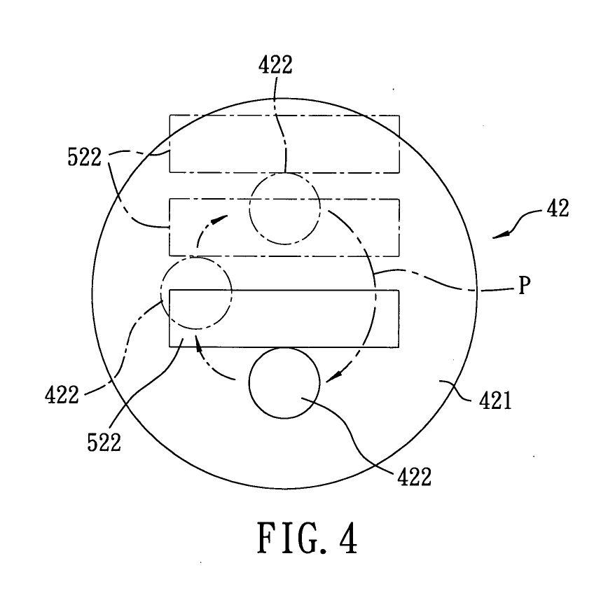

With further reference to FIG. 4, the rotary driving member 42 includes a circular base plate 421 and a cylindrical drive post 422 extending from the base plate 421. The base plate 421 is coupled to and is driven by the power mechanism 41 to rotate about an axis (X). The drive post 422 extends forwardly from the base plate 421, and extends parallel to and is offset from the axis (X). In this embodiment, the drive post 422 is disposed proximate to a peripheral edge of the base plate 421.

The cutting unit 5 is disposed in front of the electric driving unit 4 and is used to cut an object 20. The cutting unit 5 includes a first cutting member 51, a second cutting member 52, and a biasing member 53.

The first cutting member 51 includes a mounting section 511 having front and rear ends, a first pivot section 512 connected to the front end of the mounting section 511, and a first blade section 513 extending forwardly from the pivot section 512. In this embodiment, the electric driving unit 4 has opposite first and second sides (i.e., upper and lower sides) relative to the axis (X), and the rear end of the mounting section 511 is disposed to be fixed relative to the first (upper) side of the electric driving unit 4. Preferably, the rear end of the mounting section 511 is fixed directly to the first (upper) side of the electric driving unit 4.

The second cutting member 52 includes a second pivot section 521 connected pivotally to the first pivot section 512 of the first cutting member 51 by a pivot 50, a driven section 522 extending rearwardly from the second pivot section 521 and driven by the rotary driving member 42, and a second blade section 523 extending forwardly from the pivot section 521. The driven section 522 abuts against the drive post 422 of the rotary driving member 42. With further reference to FIG. 4, the drive post 422 moves along a circular path (P) upon rotation of the base plate 421. The driven section 522 of the second cutting member 52 is formed with a driven end that is remote from the second pivot section 521 and that extends in a chordal direction relative to the circular path (P) of the drive post 422.

In this embodiment, the biasing member 53 is a compression spring that is disposed between and that has opposite ends abutting respectively against the mounting section 511 of the first cutting member 51 and the driven section 522 of the second cutting member 52. The biasing member 53 provides an urging force to maintain abutment between the driven section 522 of the second cutting member 52 and the drive post 422 of the rotary driving member 42. In this embodiment, the biasing member 53 biases the driven section 522 away from the mounting section 511 of the first cutting member 51, i.e., away from the first (upper) side of the electric driving unit 4, thereby moving the first and second blade sections 513, 523 of the first and second cutting members 51, 52 away from each other.

In use, the power switch 311 on the handle portion 31 of the casing 3 is operated to activate the power mechanism 41 of the electric driving unit 4. When the base plate 421 of the rotary driving member 42 is driven rotatably by the power mechanism 41, the drive post 422 will move along the circular path (P) from the second (lower) side of the electric driving unit 4 to the first (upper) side of the electric driving unit 4. Since the driven section 522 of the second cutting member 52 abuts against the drive post 422, the driven section 522 of the second cutting member 52 will be moved from an initial position remote from the mounting section 511 of the first cutting member 51 (see FIG. 2) to a cutting position proximate to the mounting section 511 of the first cutting member 51 (see FIG. 3) against the biasing action of the biasing member 53. As the driven section 522 moves from the initial position to the cutting position, the second cutting member 52 pivots relative to the first cutting member 51 about the pivot 50 to bring the second blade section 523 toward the first blade section 513 of the first cutting member 51, thereby cutting the object 20 that is disposed between the first and second blade sections 513, 523.

Thereafter, when the power mechanism 41 continues to drive rotation of the base plate 421 of the rotary driving member 42 about the axis (X), the drive post 422 will move along the circular path (P) from the first (upper) side of the electric driving unit 4 back to the second (lower) side of the electric driving unit 4. As a result, the driven section 522 of the second cutting member 52 will be moved from the cutting position back to the initial position through the biasing action of the biasing member 53, and the second cutting member 52 pivots relative to the first cutting member 51 about the pivot 50 to bring the second blade section 523 away from the first blade section 513 of the first cutting member 51 in preparation for another cutting operation.

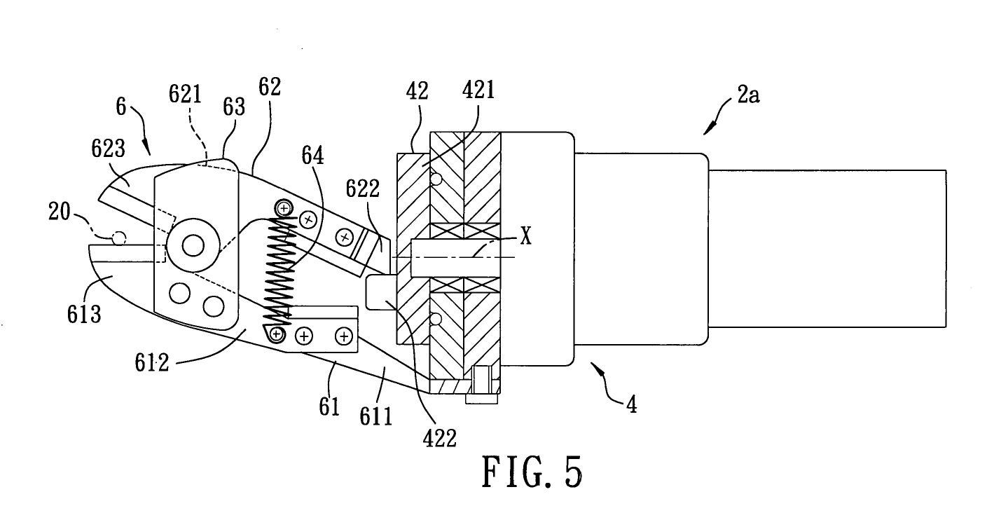

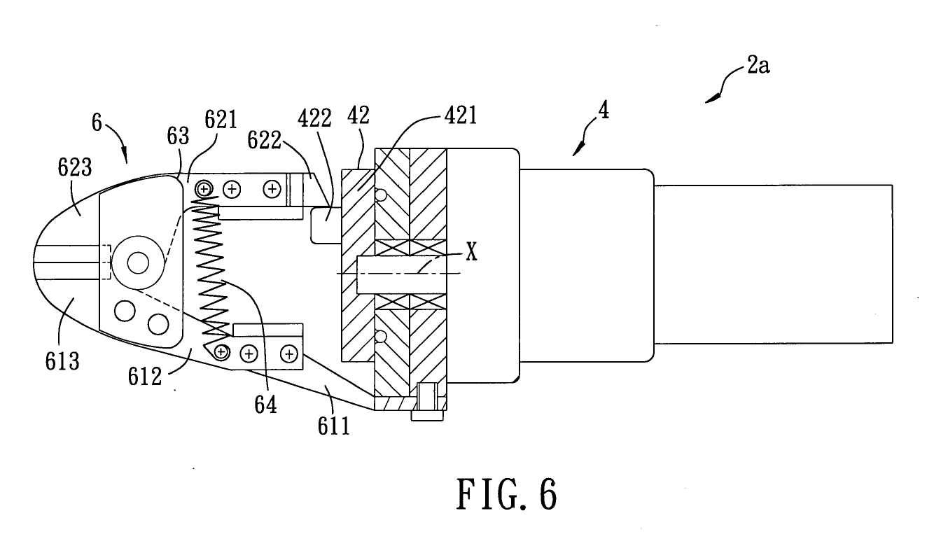

FIGS. 5 and 6 illustrate the second preferred embodiment of a power cutting tool 2a according to the present invention. The power cutting tool 2a of this embodiment differs from the previous embodiment in the construction of the cutting unit 6.

In this embodiment, the cutting unit 6 is similarly disposed in front of the electric driving unit 4 and is used to cut an object 20. The cutting unit 6 includes a first cutting member 61, a second cutting member 62, a pivot connection member 63, and a biasing member 64.

The first cutting member 61 includes a mounting section 611 having front and rear ends, a connecting section 612 connected to the front end of the mounting section 611, and a first blade section 613 extending forwardly from the connecting section 612. In this embodiment, the electric driving unit 4 has opposite first and second sides (i.e., lower and upper sides) relative to the axis (X) of rotation of the base plate 421 of the rotary driving member 42, and the rear end of the mounting section 611 is disposed to be fixed relative to the first (lower) side of the electric driving unit 4. Preferably, the rear end of the mounting section 611 is fixed directly to the first (lower) side of the electric driving unit 4.

The second cutting member 62 includes a pivot section 621, a driven section 622 extending rearwardly from the pivot section 621 and driven by the rotary driving member 42, and a second blade section 623 extending forwardly from the pivot section 621. The driven section 622 abuts against the drive post 422 of the rotary driving member 42. The relationship between the driven section 622 and the drive post 422 is the same as that described hereinabove in connection with the previous embodiment.

In this embodiment, the pivot connection member 63 includes a pair of connection plates that are disposed on opposite sides of the first and second cutting members 61, 62, that are connected fixedly to the connecting section 612 of the first cutting member 61, and that are connected pivotally to the pivot section 621 of the second cutting member 62, thereby permitting pivoting movement of the second cutting member 62 relative to the first cutting member 61 in response to rotation of the rotary driving member 42.

In this embodiment, the biasing member 64 is an extension spring that is disposed between and that has opposite ends connected respectively to the mounting section 611 of the first cutting member 61 and the driven section 622 of the second cutting member 62. The biasing member 64 provides an urging force to maintain abutment between the driven section 622 of the second cutting member 62 and the drive post 422 of the rotary driving member 42. In this embodiment, the biasing member 64 biases the driven section 622 toward the mounting section 611 of the first cutting member 61, i.e., toward the first (lower) side of the electric driving unit 4, thereby moving the first and second blade sections 613, 623 of the first and second cutting members 61, 62 away from each other.

In use, when the base plate 421 of the rotary driving member 42 is driven rotatably by the power mechanism 41, the drive post 422 will move from the first (lower) side of the electric driving unit 4 to the second (upper) side of the electric driving unit 4. Since the driven section 622 of the second cutting member 62 abuts against the drive post 422, the driven section 622 of the second cutting member 62 will be moved from an initial position proximate to the mounting section 611 of the first cutting member 61 (see FIG. 5) to a cutting position remote from the mounting section 611 of the first cutting member 61 (see FIG. 6) against the biasing action of the biasing member 64. As the driven section 622 moves from the initial position to the cutting position, the second cutting member 62 pivots relative to the first cutting member 61 to bring the second blade section 623 toward the first blade section 613 of the first cutting member 61, thereby cutting the object 20 that is disposed between the first and second blade sections 613, 623.

Thereafter, when the power mechanism 41 continues to drive rotation of the base plate 421 about the axis (X), the drive post 422 will move from the second (upper) side of the electric driving unit 4 back to the first (lower) side of the electric driving unit 4. As a result, the driven section 622 of the second cutting member 62 will be moved from the cutting position back to the initial position through the biasing action of the biasing member 64, and the second cutting member 62 pivots relative to the first cutting member 61 to bring the second blade section 623 away from the first blade section 613 of the first cutting member 61 in preparation for another cutting operation.

In sum, the power cutting tool (2, 2a) of this invention permits the cutting of relatively hard objects without requiring the user to exert a large force.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A power cutting tool comprising:
an electric driving unit including a rotary driving member; and
a cutting unit including a first cutting member and a second cutting member pivotable relative to said first cutting member, said second cutting member being driven by said rotary driving member such that rotation of said rotary driving member results in pivoting movement of said second cutting member relative to said first cutting member for cutting an object disposed between said first and second cutting members.

2. The power cutting tool as claimed in claim 1, further comprising a casing having said electric driving unit mounted therein.

3. The power cutting tool as claimed in claim 1, wherein said electric driving unit further includes a power mechanism coupled to and operable so as to drive rotatably said rotary driving member.

4. The power cutting tool as claimed in claim 3, wherein said rotary driving member includes a base plate coupled to and driven by said power mechanism to rotate about an axis, said electric driving unit having opposite first and second sides relative to the axis,
said first cutting member including a mounting section having a front end and a rear end disposed to be fixed relative to said first side of said electric driving unit, a first pivot section connected to said front end of said mounting section, and a first blade section extending forwardly from said first pivot section,
said second cutting member including a second pivot section connected pivotally to said first pivot section of said first cutting member, a driven section extending rearwardly from said second pivot section and driven by said rotary driving member, and a second blade section extending forwardly from said second pivot section.

5. The power cutting tool as claimed in claim 4, wherein said mounting section of said first cutting member is fixed directly to said first side of said electric driving unit.

6. The power cutting tool as claimed in claim 4, wherein said rotary driving member further includes a drive post that extends forwardly from said base plate and that extends parallel to and that is offset from the axis, said driven section of said second cutting member abutting against said drive post.

7. The power cutting tool as claimed in claim 6, wherein said drive post moves along a circular path relative to the axis upon rotation of said base plate, said driven section of said second cutting member being formed with a driven end that is remote from said second pivot section and that extends in a chordal direction relative to the circular path of said drive post.

8. The power cutting tool as claimed in claim 6, wherein said cutting unit further includes a biasing member disposed between said first and second cutting members for providing an urging force to maintain abutment between said driven section of said second cutting member and said drive post.

9. The power cutting tool as claimed in claim 8, wherein said biasing member is a compression spring that is disposed between and that has opposite ends abutting respectively against said mounting section of said first cutting member and said driven section of said second cutting member.

10. The power cutting tool as claimed in claim 3, wherein said rotary driving member includes a base plate coupled to and driven by said power mechanism to rotate about an axis, said electric driving unit having opposite first and second sides relative to the axis,
said first cutting member including a mounting section having a front end and a rear end disposed to be fixed relative to said first side of said electric driving unit, a connecting section connected to said front end of said mounting section, and a first blade section extending forwardly from said connecting section,
said second cutting member including a pivot section, a driven section extending rearwardly from said pivot section and driven by said rotary driving member, and a second blade section extending forwardly from said pivot section,
said cutting unit further including a pivot connection member for connecting pivotally said pivot section of said second cutting member to said connecting section of said first cutting member.

11. The power cutting tool as claimed in claim 10, wherein said mounting section of said first cutting member is fixed directly to said first side of said electric driving unit.

12. The power cutting tool as claimed in claim 10, wherein said rotary driving member further includes a drive post that extends forwardly from said base plate and that extends parallel to and that is offset from the axis, said driven section of said second cutting member abutting against said drive post.

13. The power cutting tool as claimed in claim 12, wherein said drive post moves along a circular path relative to the axis upon rotation of said base plate, said driven section of said second cutting member being formed with a driven end that is remote from said second pivot section and that extends in a chordal direction relative to the circular path of said drive post.

14. The power cutting tool as claimed in claim 12, wherein said cutting unit further includes a biasing member disposed between said first and second cutting members for providing an urging force to maintain abutment between said driven section of said second cutting member and said drive post.

15. The power cutting tool as claimed in claim 14, wherein said biasing member is an extension spring that is disposed between and that has opposite ends connected respectively to said mounting section of said first cutting member and said driven section of said second cutting member.

16. The power cutting tool as claimed in claim 10, wherein said pivot connection member includes at least a connecting plate connected fixedly to said connecting section of said first cutting member and connected pivotally to said pivot section of said second cutting member.
